(19) United States
(12) Patent Application Publication
(10) Pub. No.: US 2011/0145160 A1
(43) Pub. Date: Jun. 16, 2011

(54) INFORMATION POSTING BY STRATEGIC USERS IN A SOCIAL NETWORK

(75) Inventors: Mohammad Hajiaghayi, Florham Park, NJ (US); Liviu Iftode, Princeton, NJ (US); Raluca Mihaela Ursu, South Hadley, MA (US); Mangesh Charudatta Gupte, Piscataway, NJ (US); Lu Han, Piscataway, NJ (US); Pravin Shankar, Piscataway, NJ (US)

(73) Assignee: AT&T Intellectual Property I, L.P., Reno, NV (US)

(21) Appl. No.: 12/636,237

(22) Filed: Dec. 11, 2009

(51) Int. Cl. G06Q 10/00; G06F 9/455; G06Q 30/00; G06Q 99/00; G06F 3/00; G06Q 20/00

(52) U.S. Cl. 705/319; 703/23; 705/14.16; 705/348; 715/753; 705/7.41

(57) ABSTRACT

Embodiments are directed to modeling propagation of an information item in an online social network. A quality value for the information item to be posted in the online social network is calculated, and the quality value is compared to a posting threshold value. The posting threshold value being determined based on a strategic user model. A propagation of the information item through the online social network is emulated based on the comparison.

This invention was made with government support under grant CNS-0831268 awarded by the National Science Foundation. The government has certain rights in the invention.

### BACKGROUND

1. Technical Field

The present invention relates to modeling user behavior in social networks.

2. Brief Discussion of Related Art

Online social networks have become an increasingly popular medium for sharing information, such as links, news, and multimedia, among users. A typical Facebook user can have 120 friends, and typically more than 30 million users update their status at least once each day. More than 5 billion minutes are spent on Facebook each day (worldwide). As a direct consequence of these trends, social networks are quickly taking over traditional web sources as a source of information.

In the early days of social networks, users tended to post predominantly personal information. Such information typically did not spread more than one hop, since only immediate friends are typically interested in this information. Over time, online social networks have metamorphosed into a forum where people post information, such as news, that they deem to be of common interest. For example, during the Iran elections in 2009, traditional news media acknowledged the power and influence of social networks, such as Twitter.

An aspect of social networks that has typically been overlooked is to understand why users post information such as news or links on social networks. It is suggested herein that users in a social network have transitioned from being passive entities to strategic users who weigh in various factors (such as how interested their friends will be in the news) when deciding whether to post information. This trend leads to several interesting questions, such as: What factors do users consider when deciding whether to post an item? How does information diffuse over the social network based on user strategies?

### SUMMARY

In one aspect, a method for modeling propagation of an information item in an online social network is disclosed. The method includes calculating a quality value for the information item to be posted in the online social network and comparing the quality value to a posting threshold value. The posting threshold value being determined based on a strategic user model. The method also includes emulating a propagation of the information item through the online social network based on the comparing.

In another aspect, a computer readable medium storing instructions executable by a computing system including at least one computing device is disclosed. Execution of the instructions implements a method for modeling propagation of an information item in an online social network that includes calculating a quality value for the information item to be posted in the online social network and comparing the quality value to a posting threshold value. The posting threshold value being determined based on a strategic user model. The method implemented by the execution of the instructions also includes emulating a propagation of the information item through the online social network based on the comparing.

In yet another aspect, a system for modeling propagation of an information item in an online social network. The system a computing system having one or more computing devices. The computing system calculates a quality value for the information item to be posted in the online social network and compares the quality value to a posting threshold value. The posting threshold value being determined based on a strategic user model. The computing system also emulates a propagation of the information item through the online social network based on the comparing.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 shows an exemplary computing system in which an online social network can be implemented.

FIG. 2 is a block diagram of an exemplary of a strategic user modeling tool.

FIG. 3 is a block diagram of an exemplary computing device for implementing embodiments of a strategic user modeling tool.

FIG. 4 is a flowchart illustrating strategic user models that can be implemented by exemplary embodiments of a strategic user modeling tool.

FIG. 5 shows an exemplary computing system in which an online social network can be used for advertisement.

### DETAILED DESCRIPTION

Exemplary embodiments are directed to modeling propagation of an information item in online social networks based on strategic posting of the information by one or more users. Exemplary strategic user models, such as, for example, a greedy strategy and a courteous strategy can be used to model the propagation of an information item. An information item can refer to a link or other information posted by user that is not personal in nature. For example, an information item can include, but is not limited to a post relating to a coupon, discount, incentive, reward, news article, real estate listing, offers for sale, and the like. A strategic user model emulates user behavior in a social network when determining whether to post an information item.

For a suitable random graph model of a social network, propagation of an information item can follow a threshold phenomenon, for which a “high-quality” information item provably spreads throughout the social network assuming users adhere to the strategic user models (e.g., greedy strategy and/or courteous strategy). The threshold can depend on how aggressive users are about posting the information item. If the quality of the information item is smaller than this threshold, a sub-linear number of nodes in the network post the information. Using the strategic user models, a framework for advertisement and marketing can be implemented for online social networks. As such, the strategic user model can have applications in advertising, marketing, and the like. In some embodiments, an incentive scheme can be implemented based on the strategic user models to encourage strategic users to advertise products over social networks.

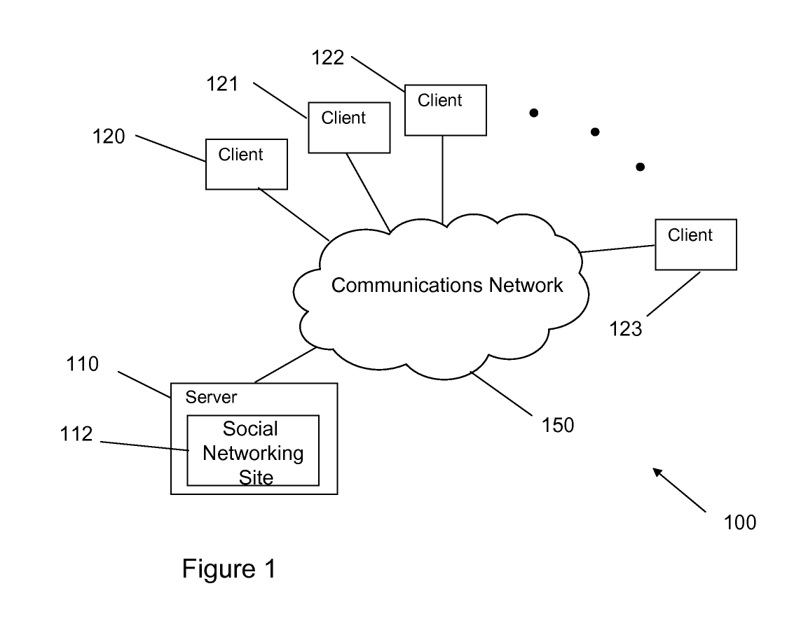

FIG. 1 is an exemplary computing system 100 in which an online social network can be implemented. The computing system 100 includes a server device 110 (hereinafter “server 110”) coupled to client devices 120-123 (hereinafter “clients 120-123”), via a communication network 150, which can be any network over which information can be transmitted between devices communicatively coupled to the network. For example, the communication network 150 can be the Internet, intranet, Virtual Private Network (VPN), Local Area Network (LAN), Wide Area Network (WAN), and the like. The server 110 and client devices 120-123 can be implemented using computing devices.

The server 110 can be configured to provide a social networking environment to the clients 120-123. For example, the server 110 can be configured as a web server to provide an online social networking website 112. Users of the social network can form connections with other users of the social network and can disseminate information to, and receive information from, other user with whom the user is connected. User that are connected to each other via a single hop (e.g., directly connected, such as friends in Facebook) are referred to herein as neighbors. The server 110 can maintain user information and connections to other users, as well as information that users post. Some examples of social networks can include, but are not limited to Facebook, Twitter, Linkedln, Plaxo, MySpace, and the like.

The clients 120-123 can be configured to be communicatively coupled to the server 110 via the communication network 150. The clients 120-123 can execute applications for interfacing with the server 110 to send information to, and receive information from, the server 110. For example, the clients 120-123 can be configured to implement a web browser for interfacing with the server 110 to allow a user to retrieve, view, and post information on the social network, and/or to interact with other users of the social network with whom the user is connected. The clients can be implemented as, for example, a personal computer (PC), laptop computer, workstation, handheld device, such as a portable digital assistant (PDA) and/or smart phone, and the like.

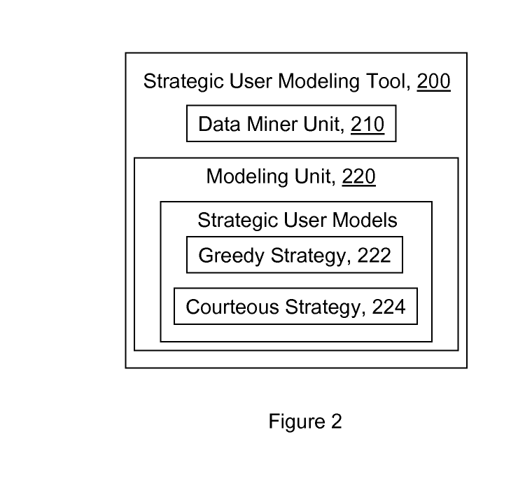

FIG. 2 is an exemplary strategic user modeling tool 200 (hereinafter “tool 200”) for modeling strategic user behavior. The tool 200 can include a data miner unit 210 and a modeling unit 220. The tool 200 can obtain a dataset of users associated with a social network, as well as connections between the users, and can model the propagation of information items posted by a user through the social network based on a strategic user model, such as a greedy strategy or a courteous strategy.

The data miner unit 210 can crawl a social network to form a graph of the social network. Crawling refers to automatically browsing a social network to identify and extract a structure of the social network and information included in the social network. In some embodiments, the data miner unit 210 can remove hub users, which can represent users who have a number of connections to other users that exceeds a specified hub value. For example, the data miner unit 210 can remove users that have over 500 connections. The graph formed in response to crawling the social network can include nodes representing users of the social network and edges representing connections between the users of the social network. Nodes that are directly connected via a single edge in the graph are neighbors.

The modeling unit 220 can implement a strategic user model, such as a greedy strategy 222 and/or a courteous strategy 224, for modeling the propagation of information item posts in a social network. The modeling unit can emulate the propagation of an information item based on the strategic user model to calculate a level of coverage that can be achieved using the information item. A level of coverage can refer to an amount of users in the social network that see the information item divided by a total amount of users in the social network. Emulation can refer to a simulation or statistical processing to predict and/or model the propagation of information in the social network.

For a particular user u in the social network, such as Facebook and/or Twitter, whenever the user u first sees a previously unseen information item, the user u has the option of either posting the information item or not posting the information item. A utility value of 0 is associated with the user u if the user u does not post the information item. If the user u does post the information item, the utility value depends on: (1) the set Iᵤ of neighbors who are interested in the information item, and (2) the set Sᵤ of neighbors who, the user u knows, have already seen the information item before.

In some embodiments, the set Iᵤ can be identified by the operator of the social network, for example, by tracking and/or monitoring posts by users in the social network. For example, the social network operator can identify an information item posted by user u and can monitor the user u's neighbors (i.e., those users that are directly linked to user u) to determine if the neighbors post the information item within a specified period of time. If the neighbors post the information item, the tool 200 can determine that the neighbors who posted the information item were interested in the information item. In some embodiments, the interest of the neighbors can be determined based on whether the neighbors of user u select and/or view the information item posted by the user u. If a neighbor selects and/or views the information item, the neighbor can be included in the set Iᵤ.

In some embodiments, the set Sᵤ can be identified based on which neighbors have posted the information item. Those neighbors who have not posted the information item can be included in the set Sᵤ. The user u may not know the true set of neighbors who have seen the information item since it may be true that some users who see the information item will not post the information. However, the user u can know that a neighbor has seen the information item if a mutual neighbor has posted the information item. This can mean that an assumption is made that users know which of their connections are connected to each other. In some embodiments, the set Sᵤ can be determined based on whether the neighbors of user u select and/or view the information item posted by another user. If a neighbor selects and/or views the information item posted by a user other than use u, the neighbor can be included in the set Sᵤ.

The set Nᵤ can be used to denote the set of the user u's neighbors (e.g., users that are directly connected to the user u, such as friends in Facebook). The utility value associated with the user u can be represented using the greedy strategy 222 and/or a courteous strategy 224.

Under the greedy strategy 222 implemented by the modeling unit 220 of the tool 200, the utility of user u is additive and for every neighbor who likes the information item (irrespective of whether the neighbor has seen it before or not), the user u gets utility having a value of +a, and for every neighbor who does not like the new, the user u gets utility having a value of −b. In some embodiments, it can be determined by the tool 200 that a neighbor is not interested in the posted information item if the neighbor does not post the information item. In the greedy strategy case, the decision by user u to post can depend on a, b, and fraction fᵤ, which can represent the quotient of the number of neighbors who are interested in the news item (|Iᵤ|) divided by the number of the user u's neighbors (|Nᵤ|), which can be represented mathematically as

$${f}_{u} = \frac{\vert {I}_{u} \vert}{\vert {N}_{u} \vert} .$$

User u posts the information unit if the fraction fᵤ of users who like the news satisfies a·fᵤ−b(1−fᵤ)>0 [symbol] fᵤ>t, where

$$t = \frac{b}{a + b}$$

and t represents a posting threshold. Thus, the greedy strategy 222 predicts that a user u posts an information item if the fraction fᵤ is greater than the posting threshold t.

Under the courteous strategy 224, a difference from the greedy strategy 222 is that the user u may not want to spam neighbors. This can be model as follows. If a value of a fraction calculated as the user u's friends that have already seen the news before divided by the user u's neighbors

$$( \frac{\vert {S}_{u} \vert}{\vert {N}_{u} \vert} )$$

exceeds a courteous threshold c, the user u gets a large negative utility, if the user u posts the information item. If a user does not post the information item, the user u's utility is 0. For the case where the fraction

$$\frac{\vert {S}_{u} \vert}{\vert {N}_{u} \vert}$$

is less than or equal to the courteous threshold c, the user u's utility is the same as in the greedy strategy 222. In particular, the user u gets a utility of +a for every neighbor who likes the information item and has not seen it before (the set formed by the difference between Iᵤ and Sᵤ expressed as Iᵤ\Sᵤ), and the user u gets utility −b for every neighbor who does not like it (the set formed by the difference between Iᵤ^{c} and Sᵤ expressed as Iᵤ^{c}\Sᵤ, where Iᵤ^{c} is a complimentary set of Iᵤ). Hence, the modeling unit of the tool 200 identifies the user u's strategy under the courtesy strategy 224 as posting an information item if an inhibit value represented as fraction of neighbors who have seen the information item

$$\frac{\vert {S}_{u} \vert}{\vert {N}_{u} \vert}$$

is less than or equal to the courteous threshold and if the fraction

$$fu = \frac{\vert {I}_{u} \backslash {S}_{u} \vert}{\vert {N}_{u} \backslash {S}_{u} \vert}$$

of neighbors in Sᵤ^{c} who are interested in the information item is greater than or equal to posting threshold t, where Sᵤ^{c} is the complementary set of Sᵤ. In this utility function, if a larger number of the user u's neighbors have posted the information item, the user u is less likely to post the information item.

Some notations and preliminaries are provided. Given a real symmetric matrix P with 0≦p_{i,j}≦1, a random graph can be denoted as G(n; P) where an edge (i,j) exists with probability p_{i,j}. For notational convenience a deterministic graph associated with the random graph G(n; P) can be denoted as W_{P}=(V,E_{P}) with V representing the vertex set, E representing a set of edges, and P representing an adjacency matrix. The probability p_{i,j} gives the weight of edge (i,j) in W_{P}. The random graph G(n, P) can be a generalization of Stochastic Kronecker Graphs as well as the Erdõs and Rènyi model of Random Graphs G(n,p), and the model of random graphs with a given degree sequence.

The properties of the random graph G(n, P) can be defined based on cuts. A cut refers to a partition of the vertices of a graph into disjoint subsets. Cuts can be visualized as an imaginary cut through edges of the random graph to separate the graph into sub-graphs. The density of a cut can be determined as follows. Given a graph G=(V,E), the density of the cut (S, V−S) can be defined as

$$\frac{\vert E ( S , V - S ) \vert}{\vert S \vert \vert V - S \vert} ,$$

where E(S,V−S) denotes the set of edges between S and V−S, V represents the set of vertices, and S represents a subset of the vertices. The partition (S, V−S) that minimizes this density is called the Sparsest Cut in the graph. As such, the sparest cut represents a cut for which a ratio of the number of edges across the cut divided by the number of vertices in the smaller half of the partition is minimized.

A α-balanced cut can be defined as follows. Given a graph G=(V,E) and a cut (S,V−S), the cut is α-balanced if and only if min{|S|,|V−S|}≧α|V|. The term balanced cut generally refers to a cut that generates at least an approximate bisection of the graph. A sparsest α-balanced cut refers to a cut with the minimum density over all cuts that are α-balanced.

To prove the graph G is connected, if the size of the min-cut in deterministic graph W_{P} is greater than c log n, then with high probability, the sampled graph G:G(n,P) is connected, where high probability means with probability of 1−o(1).

Given a set U that is a subset of the set of Vertices V (U⊂V), the subgraph induced by the set U can be represented as G[U]. The induced subgraph of W_{P} can be denoted by W_{P}[U]. The following gives a sufficient condition on the existence of a giant component in the graph G(n,P). If there exists U⊂V, of size n, such that the sparsest α-balanced cut of W_{P}[U] has density greater than

$$\frac{c}{\vert U \vert} ,$$

then there is a giant connected component in G[U] of size n with high probability.

The greedy strategy can be analyzed for a random graph G(n,P)=(V,E). According to the greedy strategy model, a user posts if the fraction of interested neighbors is greater than the posting threshold t. For a given information item, it can be assumed that each user in the network likes the information item with probability q, which is independent of everything else. Probability q can model the quality of the information item or the inherent interest the subject generates. In some embodiments, the probability q can be determined based on the fraction fu is defined for the greedy strategy and/or the courteous strategy. In some embodiments, the value of the probability q and posting threshold t can be constants that do not depend on the number of nodes n in the random graph G.

A scheme can be used to identify an interest of users represented as nodes in the random graph. For example, if a user is interested in the information item that is posted, the node that corresponds to the user in the random graph G can be colored yellow. If the user is not interested in the information item, the node in the random graph G corresponding to the node can be colored blue. A yellow node is responsive if more than at fraction of its neighbors are interested in the information item. Responsive nodes can be colored red. A node is responsive if the fraction of neighbors that are interested in the information item is greater than or equal to the posting threshold t. A responsive node in the graph represents a user that will post the information item if the user receives the information item. The sets of yellow, blue, and red nodes can be denoted by Y, B, and R, respectively. Note that R⊂Y. A graph G[R] represents the graph induced by the red nodes, the structure of which is of interest.

Proposition 1: Suppose that the random graph G(n; P) is such that the min-cut in W_{P} is of weight greater than or equal to c log n and that log n random nodes in the social network initially see the information item. If the value of the probability q is greater than the value of the posting threshold t, with high probability, almost all nodes interested in the information item will post the information item. High probability can refer to probability 1−o(1). On the other hand, if the value of the probability q is less than the value of the posting threshold t then only a sub-linear number of the users will post the information item.

Proposition 2. Suppose the random graph G(n,P) is such that the sparsest α-balanced cut in W_{P} has density greater than or equal to the value of courteous threshold c divided by the number of nodes n and that log n random nodes in the network initially see the information item. If the value of probability q is greater than the posting threshold t then, with high probability, a constant fraction of the nodes interested in the information item post the information item.

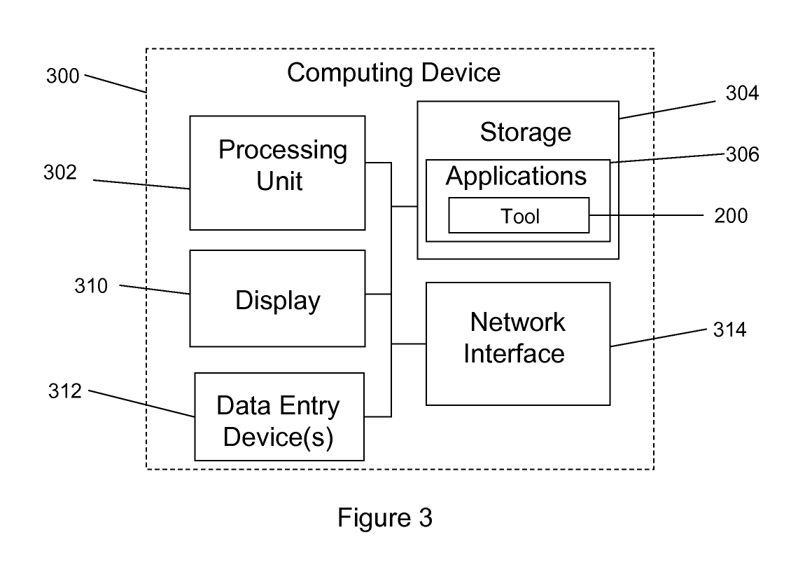

FIG. 3 is a block diagram of an exemplary computing device 300 configured to implement embodiments of the tool 200. The computing device 300 can be a mainframe, personal computer (PC), laptop computer, workstation, handheld device, such as a portable digital assistant (PDA) and/or smart phone, and the like. The computing device 300 can be integrated with the server 110 and/or communicatively coupled to the server 110. In the illustrated embodiment, the computing device 300 includes one or more processing unit 302, such as a central processing units (CPUs) and/or graphical processing units (GPUs), and can include storage 304. In some embodiments, the computing device 300 can further include or be communicatively coupled to a display device 310 and data entry device(s) 312, such as a keyboard, touch screen, and/or mouse.

The storage 304 stores data and instructions and can be implemented using one or more computer readable medium technologies, such as a floppy drive, hard drive, tape drive, Flash drive, optical drive, read only memory (ROM), random access memory (RAM), and the like. Applications 306, such as the tool 200, or portions thereof, can be resident in the storage 304. The instructions can include instructions for implementing embodiments of the tool 200. The one or more processing units 302 execute the applications 306, such as the tool 200, in storage 304 by executing instructions therein and storing data resulting from the executed instructions. The storage 304 can be local or remote to the computing device 300. The computing device 300 can include a network interface 314 for communicating with a network, such as the communication network 150 of FIG. 1.

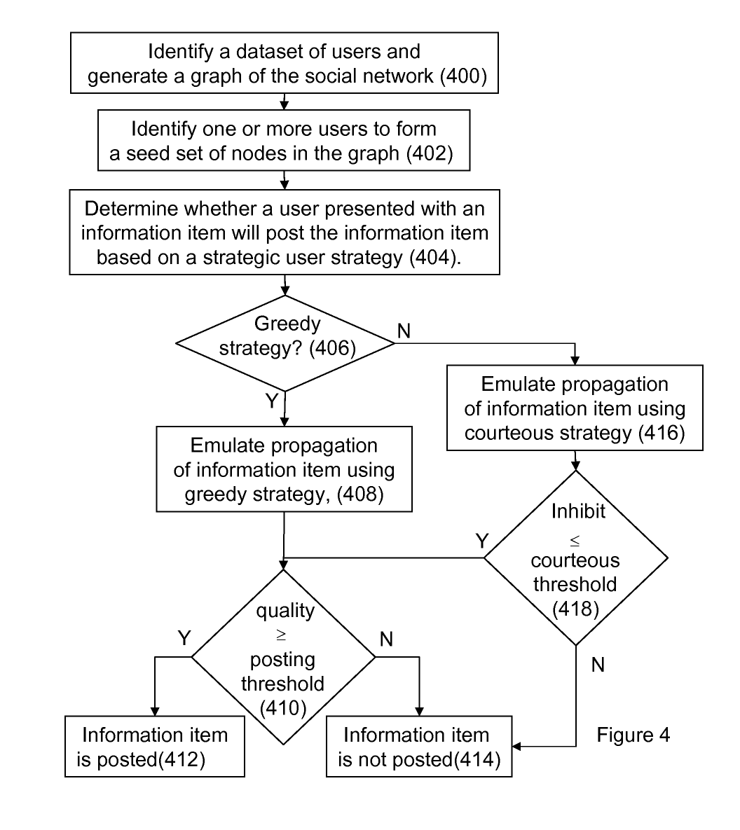

FIG. 4 is a flowchart illustrating strategic user models that can be implemented by exemplary embodiments of the tool 200 (FIG. 2). The tool can crawl a social network to identify a dataset of users and generate a graph of the social network (400). The dataset identified by the tool, and the graph generated by the tool, can omit hub users. The tool can identify one or more users to form a seed set of nodes in the graph (402). For example, the tool can select a set of seed nodes of size logn, where n represents the number of nodes in the graph.

An iterative process is performed to determine whether a user presented with an information item will post the information item based on the greedy strategy or the courteous strategy (404). If the iterative process is to be performed by the tool using the greedy strategy (406), the tool emulates the propagation of the information item using the greedy strategy (408). If the quality of the information item is greater than or equal to the posting threshold t (410), the tool emulates the propagation as if the user posts the information item (412). Otherwise, the tool emulates the propagation of the information item as if the user does not post the information item (414). The quality q of the information item can be determined for the greedy strategy based on the fraction of neighbors interested in the information item divided by the number of neighbors the user has

$$( {f}_{u} = \frac{\vert {I}_{u} \vert}{\vert {N}_{u} \vert} ) .$$

If the iterative process is to be performed by the tool using the courteous strategy (406), the tool emulates the propagation of the information item using the courteous strategy (408). If fraction formed by the number of neighbor who have seen already seen the information item divided by the number of neighbors the user has (i.e. the inhibit value) is less than or equal to a courteous threshold c (418) and the quality of the information item is greater than or equal to the posting threshold t (410), the tool emulates the propagation of the information item as if the user posts the information item (412). Otherwise, the tool emulates the propagation of the information item as if the user does not post the information item (414). The quality q of the information item can be determined for the courteous strategy based on the fraction

$$fu = \frac{\vert {I}_{u} \backslash {S}_{u} \vert}{\vert {N}_{u} \backslash {S}_{u} \vert} .$$

The above process can be performed for each user that receives the information and has the option to either post the information item or not post the information item. Using this process, the propagation of an information item in a social network can be modeled. A level of coverage can be calculated based on a fraction of interested users in the social network who get to the information item.

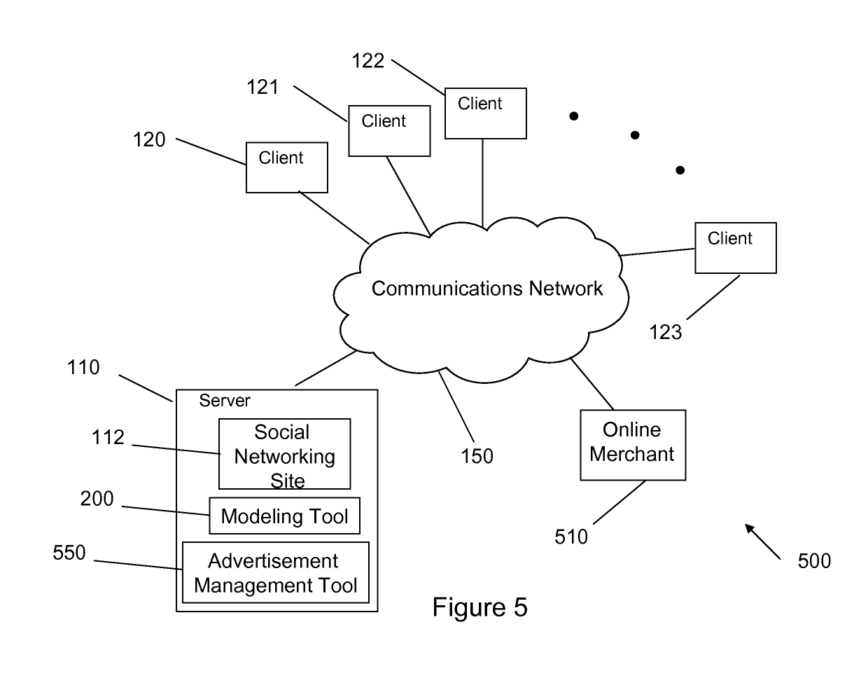

FIG. 5 is an exemplary computations system 500 in which an online social network can be used for advertisement. The system can include the server 110, clients 120-123, communications network 150, and an entity 510, such as an online merchant. The entity 500 can represent an online presence of a company that wants to advertise to potential customers. Some examples of the entity 510 can include, but are not limited to Gap, Marshalls, Sears, Target, Wal-Mart, Nike, and the like. Users of the clients 120-123 can interface with the entity 510 via the communications network 150 using, for example, a web browser. One or more of the clients 120-123 can interact with the entity 510 to purchases goods and/or service online. For example, the entity 510 can have a website from which clients 120-123 can buy goods or services. The users of the clients 120-123 can have accounts to one or more online social networking sites that the entity wishes to use for distributing advertisements.

As one exemplary implementation, a user of the client 123 can purchase an online item from the website of the entity 510. When the user is checking out, the website of the entity 510 can ask the user of the client 123 whether he wants to an incentive, such as a discount, coupon, rewards points, and the like, in exchange for allowing the entity to advertise to the user's connections in one or more online social networks (e.g., friends in Facebook). For example, the entity may wish to advertise to the user's connections via the online social network that the user has purchased a specific good and/or service from the entity 510.

If the user agrees to allow the entity 510 to distribute the advertisement to the user's connections, the website of the entity 510 transfers the client 123 to the server 110. In the present embodiment, the server 110 can implement the online social network 112, the strategic user modeling unit 200, and an advertisement management tool 550. In other embodiments, the online social network 112, the strategic user modeling unit 200, and/or an advertisement management tool 550 can be implemented by separate servers. When the entity 510 transfers the user to the server 110, the entity 510 can pay an advertising fee to the operator of the advertisement management tool 550 in exchange for the operator's handling of the advertisement.

The advertisement management tool 550 can determine likelihood of propagation of the advertisement, which represents an information item based on, for example, a history, number of friends of the user, strategic user models, and the like. For example, the advertisement management tool 550 can interface with the strategic user modeling unit 200 to determine the level of coverage that can be achieved by posting the advertisement to the user's connections. Based on this information, the advertisement management tool 550 can determine how much of a discount, how many reward points, a value of a coupon, and the like that the user should receive for allowing the entity 510 to post the advertisement to the user's connections. In some embodiments the advertisement management tool 550 and the strategic user modeling unit can be separate applications. In some embodiments, the advertisement management tool 550 and the strategic user modeling unit can form an integrated application.

To implement the advertisement scheme, the online social network 112 implemented by the server 110 asks the user to enter the user's user name and password. Upon entry of this information, the online social network posts the advertisement to the users connected to the user in the online social network 112. The advertisement can include, for example, a post that says “User bought item from the entity 510”. The advertisement can also include, for example, additional discounts, reward points, coupons, and the like, that can be used by the users in subsequent purchases from the entity 510.

The online social network 112 of the server 110 can expend a percentage of the advertising fee that it received from entity 510 as points, discount, coupons, or cashback to user because the user allowed the advertisement to be posted on his behalf. The online social network 112 of the server 110 can determine the percentage to be expended to the user according to calculations performed based on, but not limited a history of the user, number of friends of the user, strategic user models, and the like. The online social network 112 of the server 110 can retains the remaining portion of the advertising fee as handling fee of the advertisement.

### Proof of Proposition 1

It can be assumed that G:G(n,P) where P is such that the min-cut of W_{P} has weight ≧c log n, for a large enough constant c.

Lemma 1. With high probability, the min-cut of the subgraph G[Y] of G induced by the yellow vertices has size >c′ log n for some constant c′.

It is now proved that G[R] is connected by using the fact that its min-cut is large.

Theorem 1. If q>t and G:G(n,P) where P is such that the min-cut of W_{P} has weight ≧c log n, then, with high probability, every vertex in Y also belongs to R and so G[R] is connected. When q<t, then, with high probability G[R] only contains o(n) vertices.

Proof Let Y_{q} be a random variable that takes value 1 with probability q and 0 otherwise. For a node v, let d(v) denote its degree in G.

$$Case 1 \text{:} q > t \text{:} Pr v ∉ R = Pr {\sum }_{i = 1}^{d ( v )} {Y}_{q} < qd ( v ) - ( q - t ) d ( v ) \leq exp ( - \frac{{( ( q - t ) d ( v ) )}^{2}}{2 \cdot q \cdot d ( v )} ) \leq {n}^{- \frac{{( q - t )}^{2} c}{2 \cdot q}} .$$

This follows from Chernoff Bounds and the facts that Y_{q} are independent, Y_{q}=q and d(v)≧c log n. We apply the union bound to get that with probability

$$\geq 1 - {n}^{1 - \frac{{( q - t )}^{2} c}{2 \cdot q}} \geq 1 - 1 / n ( when c > \frac{2 q}{{( q - t )}^{2}} )$$

all nodes in Y also belong to R and, from above, the graph G[R] is identified as being connected.

$$Case 2 \text{:} q < t \text{:} Pr v ∈ R = Pr {\sum }_{i = 1}^{d ( v )} {Y}_{q} \geq qd ( v ) + ( t - q ) d ( v ) \leq exp ( - \frac{{( ( t - q ) d ( v ) )}^{2}}{2 ( qd ( v ) + ( t - q ) / 3 )} ) \leq {n}^{- \frac{{( t - q )}^{2} c}{t}} .$$

### Hence,

$$\vert R \vert \leq \vert Y \vert \cdot {n}^{- \frac{{( t - q )}^{2} c}{t}} \leq o ( n ) .$$

So, R only contains a sub-linear number of nodes of G.

Proof of Proposition 1: If q<t, then the proposition follows directly from Theorem 1. When q>t, Theorem 1 indicates that G[R] is connected. If any node in R receives the information item, it will be propagated to all the nodes. However, the probability that none of the nodes in R get the information item is

$$\leq {( 1 - \frac{\vert R \vert}{n} )}^{log n} = O ( {n}^{- q} ) = o ( 1 ) .$$

Hence, with high probability, almost all the nodes interested in the information item post it.

### Proof of Proposition 2

It can be assumed that G:G(n,P), where P is such that the sparsest α-balanced cut of W_{P} has density ≧c/n. The size of the sparsest-cut in G[Y] is not small.

Lemma 2. Consider the subgraph G[Y] induced by the yellow vertices. With high probability, G[Y] has a subgraph of size n whose sparsest α-balanced cut has density

$$\geq \frac{{c}^{′}}{\vert Y \vert} \geq \frac{{c}^{′}}{n} ,$$

for some constant c′.

Theorem 2. Let G be a random graph sampled from the distribution G(n,P) where the density of the sparsest α-balanced cut in the graph W_{P} is greater than c/n. If q>t, then every yellow node is red with probability >1−ε_{c}. Further, the induced graph G[R] has a giant connected component of size Θ(n) with high probability.

Proof Let Y_{q} be a random variable that takes value 1 with probability q and 0 otherwise. Let us denote the degree of node v by d(v). Since (v, V\v) is a cut,

$$\frac{d ( v )}{1 \cdot ( n - 1 )} \geq \frac{c}{n} d ( v ) \geq c .$$

$$For v ∈ Y , Pr v ∉ R = Pr {\sum }_{i = 1}^{d ( v )} {Y}_{q} < qd ( v ) - ( q - t ) d ( v ) \leq exp ( - \frac{{( ( q - t ) d ( v ) )}^{2}}{2 \cdot q \cdot d ( v )} ) \leq {e}^{- \frac{{( q - t )}^{2} c}{2 \cdot q}} = {ɛ}_{c} .$$

Hence, a constant fraction f≧1−ε_{c} of the vertices in Y belong to R. From the above, it can be proved that G[R] also has a giant connected component with high probability.

Proof of Proposition 2: By Theorem 2, G[R] contains a giant component C of size (1−ε_{c})n. If any node in C receives the information item, it will be propagated to all the nodes in C. However, the probability that none of the nodes in C get the information item is ≦(1−ε_{c})^{log n}=o(1). Hence, a constant fraction of the nodes interested in the information item actually receive it with high probability.

It is understood that the embodiments described herein can be implemented in hardware, software, or a combination of hardware and software. For example, embodiments can be implemented using a computer system configured to execute instructions of a computer program (e.g., applications), which can control an operation of the computer system such that it carries out embodiments described herein. The computer system can include one or more computing devices (e.g., service provider units), and in some embodiments the computer system can be implemented as a distributed system of networked computing devices, where the computing device can implement portions of an application, such as the diagnostic engine, to facilitate diagnosis of problems in a dual stack network. Alternatively, a specific use computer, containing specialized hardware for carrying out embodiments can be utilized.

Terms such as applications, computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While preferred embodiments of the present invention have been described herein, it is expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A method for modeling propagation of an information item in an online social network, the method comprising:
calculating a quality value for the information item to be posted in the online social network;
comparing the quality value to a posting threshold value, the posting threshold value being determined based on a strategic user model; and
emulating a propagation of the information item through the online social network based on the comparing.

2. The method of claim 1, further comprising:
identifying a user of the online social network as a seed node from which the propagation of the information item is initialized;
determining a set of neighbors associated with the user;
determining a set of neighbors that are interested in the information item; and
dividing a number of neighbors interested in the information item by a number of neighbors in the set of neighbors to calculate the quality value of the information item.

3. The method of claim 1, further comprising:
identifying a user of the online social network as a seed node from which the propagation of the information item is initialized;
determining a set of neighbors associated with the user;
determining a set of neighbors that have already seen the information item;
dividing a number of neighbors that have seen the information item by a number of neighbors in the set of neighbors to calculate the inhibit value;
comparing the inhibit value to a courteous threshold value, the courteous threshold value being determined based on a strategic user model; and
determining the likelihood of posting the information item by the user based on, at least in part, the comparing of the inhibit value to the courteous threshold.

4. The method of claim 3, further comprising:
emulating the information item as being posted by the user when the inhibit value is less than the courteous threshold value and the quality value is greater than the posting threshold value.

5. The method of claim 3, further comprising:
emulating the information item as not being posted by the user when the courteous inhibit value is greater than the courteous threshold value or the quality value is less than the posting threshold value.

6. The method of claim 1, further comprising:
emulating the information item as being posted by the user when the quality value is greater than the posting threshold value.

7. The method of claim 1, further comprising:
receiving payment of an advertising fee from an online merchant in response to a user agreeing to allow the online merchant to post an advertisement to the user's neighbors in the online social network;
calculating a percentage of the advertising fee to be used as an incentive for the user to agree to allow the online merchant to post the advertisement to the user's neighbor in the online social network based on, at least in part, the emulating; and
posting an advertisement to a user's neighbors.

8. A computer readable medium storing instructions executable by a computing system including at least one computing device, wherein execution of the instructions implements a method for modeling propagation of an information item in an online social network comprising:
calculating a quality value for the information item to be posted in the online social network;
comparing the quality value to a posting threshold value, the posting threshold value being determined based on a strategic user model; and
emulating a propagation of the information item through the online social network based on the comparing.

9. The medium of claim 8, wherein the method implemented by the execution of the instructions further comprises:
identifying a user of the online social network as a seed node from which the propagation of the information item is initialized;
determining a set of neighbors associated with the user;
determining a set of neighbors that are interested in the information item; and
dividing a number of neighbors interested in the information item by a number of neighbors in the set of neighbors to calculate the quality value of the information item.

10. The medium of claim 8, wherein the method implemented by the execution of the instructions further comprises:
identifying a user of the online social network as a seed node from which the propagation of the information item is initialized;
determining a set of neighbors associated with the user;
determining a set of neighbors that have already seen the information item;
dividing a number of neighbors that have seen the information item by a number of neighbors in the set of neighbors to calculate the inhibit value;
comparing the inhibit value to a courteous threshold value, the courteous threshold value being determined based on a strategic user model; and
determining the likelihood of posting the information item by the user based on, at least in part, the comparing of the inhibit value to the courteous threshold.

11. The medium of claim 10, wherein the method implemented by the execution of the instructions further comprises:
emulating the information item as being posted by the user when the inhibit value is less than the courteous threshold value and the quality value is greater than the posting threshold value.

12. The medium of claim 10, wherein the method implemented by the execution of the instructions further comprises:
emulating the information item as not being posted by the user when the courteous inhibit value is greater than the courteous threshold value or the quality value is less than the posting threshold value.

13. The medium of claim 8, wherein the method implemented by the execution of the instructions further comprises:
emulating the information item as being posted by the user when the quality value is greater than the posting threshold value.

14. The medium of claim 8, wherein the method implemented by the execution of the instructions further comprises:
emulating the information item as not being posted by the user when the quality value is less than the posting threshold value.

15. A system for modeling propagation of an information item in an online social network, the system comprising:
a computing system having one or more computing devices, the computing system being configured to:
calculate a quality value for the information item to be posted in the online social network;
compare the quality value to a posting threshold value, the posting threshold value being determined based on a strategic user model; and
emulate a propagation of the information item through the online social network based on the comparing.

16. The system of claim 15, wherein the computing system is further configured to:
identify a user of the online social network as a seed node from which the propagation of the information item is initialized;
determine a set of neighbors associated with the user;
determine a set of neighbors that are interested in the information item; and
divide a number of neighbors interested in the information item by a number of neighbors in the set of neighbors to calculate the quality value of the information item.

17. The system of claim 15, further comprising:
identify a user of the online social network as a seed node from which the propagation of the information item is initialized;
determine a set of neighbors associated with the user;
determine a set of neighbors that have already seen the information item;
divide a number of neighbors that have seen the information item by a number of neighbors in the set of neighbors to calculate the inhibit value;
compare the inhibit value to a courteous threshold value, the courteous threshold value being determined based on a strategic user model; and
determine the likelihood of posting the information item by the user based on, at least in part, the comparing of the inhibit value to the courteous threshold.

18. The system of claim 17, wherein the computing system is further configured to:
emulate the information item as being posted by the user when the inhibit value is less than the courteous threshold value and the quality value is greater than the posting threshold value.

19. The system of claim 17, wherein the computing system is further configured to:
emulate the information item as not being posted by the user when the courteous inhibit value is greater than the courteous threshold value or the quality value is less than the posting threshold value.

20. The method of claim 15, wherein the computing system is further configured to:
emulate the information item as being posted by the user when the quality value is greater than the posting threshold value.
